(19) United States
(12) Patent Application Publication
(10) Pub. No.: US 2015/0235633 A1
(43) Pub. Date: Aug. 20, 2015

(54) MULTI-LAYER DISPLAY SYSTEM

(71) Applicants: Chanpreet Singh, SAS Nagar (IN); Kshitij Bajaj, Sirsa (IN); Michael A. Staudenmaier, Munich (DE)

(72) Inventors: Chanpreet Singh, SAS Nagar (IN); Kshitij Bajaj, Sirsa (IN); Michael A. Staudenmaier, Munich (DE)

(21) Appl. No.: 14/185,866

(22) Filed: Feb. 20, 2014

(51) Int. Cl. G09G 5/39; G06T 9/00

(52) U.S. Cl. CPC G09G 5/39; G06T 9/00; G09G 2340/02; G09G 2340/06

(57) ABSTRACT

A multi-layer display system for displaying images including a compressed image, in multiple planes, in a single frame, includes a compressed image decoder for decoding the compressed image, multiple arbiters for reading the decoded image data, and a decoder arbitration and semaphore control unit for splitting the compressed image into segments, assigning the segments to ones of the multiple planes, and allowing at least one arbiter to access the compressed image decoder to read the decoded data of the segment assigned to a plane mapped with the arbiter when the segment is being decoded.

### BACKGROUND OF THE INVENTION

The present invention relates generally to display systems, and, more particularly, to a multi-layer display system for displaying a plurality of images on multiple planes of a single frame.

In a display screen, multiple windows are opened and viewed simultaneously, and they can be displayed at different layers and overlapped with one another, and have opaque or translucent shading. The screen can be part of any electronic device having a multi-layer display system, such as a computer, a portable device, or a television. The multiple windows can be displayed as a plurality of images and changed from frame to frame. FIG. 1 shows four images 102-108 displayed in a single frame 100. For example, in the single frame 100, the four images 102-108 are displayed at four different, overlapping layers. The four layers are arbitrated based on fixed priority, for example, the first image 102 is displayed at a first layer with a priority higher than the other layers, the second image 104 is displayed at a second layer with a priority lower than the first layer, the third image 106 is displayed at a third layer with a priority lower than the second layer, and the fourth image 108 is displayed at a fourth layer with a lowest priority among the four layers. The images 102-108 can be opaque or translucent, for example, the first and second images 102 and 104 are translucent and the third image 106 is opaque, so that the part overlapped by any two of the first, second and third images 102, 104 and 106 is blended and the part of the fourth image 108 covered by the third image 106 is not displayed. The number of images that can be displayed at different layers depends on the multi-layer display system. For example, a 32-layer display system can support up to 32 images for a single frame.

A multi-layer display system has a plurality of arbiters for displaying images on a plurality of planes each of which is mapped with one of the arbiters. The images are split and assigned to different planes. FIG. 2 shows an example of how the images 102-108 displayed in the single frame 100 are split into three planes 110-114, with the outlines of the images 102-108 remaining in dashed lines only for illustrating split segments of each of the images 102-108. Data of the images 102-108 are stored in a memory connected to the multi-layer display system. The memory can be a RAM, ROM or flash memory. The first image 102 is assigned to the first plane 110, therefore data of the first image 102 is fetched by a first arbiter mapped with the first plane 110 so that the image 102 is displayed at the first plane 110. The second image 104 is split into two segments 104a and 104b, which are respectively assigned to the first plane 110 and the second plane 112. The third image 106 is split into four segments 106a, 106b_1, 106b_2 and 106c, which are respectively assigned to the three planes 110-114. The fourth image 108 is also assigned to the first plane 110. The three planes are then blended and displayed on the screen. Image splitting and assigning is implemented by a control unit of the multi-layer display system.

Pixels of the images 102-108 displayed on the screen are mapped with data of the images stored in the memory, and each of the arbiters fetches the data of the images mapped with the pixels to be displayed at the plane mapped with the arbiter from the memory. However, if one of the images is in a compression encoded format, such as Run-Length Encoding (RLE), Joint Photographic Experts Group (JPEG), or Lempel Ziv Welch (LZW), the data should be decoded before being fetched by the arbiters. In addition, if an image in a compression encoded format is one that is split and assigned to different planes, for example, the third image 106, random access of the data in the memory for a given pixel number by the arbiters cannot be performed without prior decoding of the third image 106 due to no fixed mapping between the data and the pixels on the screen, thus, the data of the third image 106 should be pre-decoded and kept in the memory for the arbiters to access, which requires a lot of memory for the decoded data and die area for the decoders. Therefore, it would be beneficial to save the memory and die area required by the multi-layer display system.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a diagram illustrating a plurality of images displayed in a single frame overlapped with each other;

FIG. 2 is a diagram illustrating how the images to be displayed in the single frame are split into three planes;

FIG. 3 is a schematic block diagram of a multi-layer display system in accordance with an embodiment of the present invention; and

FIG. 4 is a flow chart of a method for displaying a plurality of images in multiple planes in a single frame with a multi-layer display system in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a display system for displaying a plurality of images at multiple planes in a single frame is provided. The plurality of images includes at least one compressed image. The display system includes a compressed image decoder for decoding the compressed image into a plurality of sets of decoded data, and a plurality of arbiters for reading the sets of decoded data from the compressed image decoder, wherein one of the sets of decoded data read by one of the arbiters is to be displayed at one of the multiple planes mapped with the one of the plurality of arbiters. A decoder arbitration and semaphore control unit is connected between the compressed image decoder and the arbiters for splitting the compressed image into a plurality of segments, assigning at least one of the segments to one of the multiple planes, and allowing the one of the arbiters to access the compressed image decoder to read the one of the plurality of sets of decoded data of the one of the plurality of segments assigned to the one of the multiple planes mapped with the one of the plurality of arbiters.

In another embodiment, the present invention provides a method for displaying a plurality of images at multiple planes in a single frame with a display system. The plurality of images includes at least one compressed image, and the display system includes a plurality of arbiters and a compressed image decoder for decoding the compressed image, where one of the arbiters is mapped with one of the multiple planes. The method includes splitting the compressed image into a plurality of segments, assigning at least one of the segments to the one of the multiple planes, allowing the one of the plurality of arbiters mapped with the one of the multiple planes to access the compressed image decoder; and decoding the plurality of segments into a plurality of sets of decoded data.

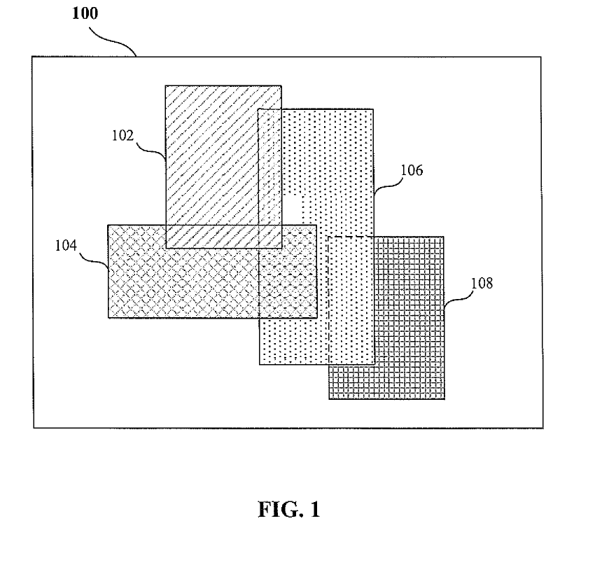

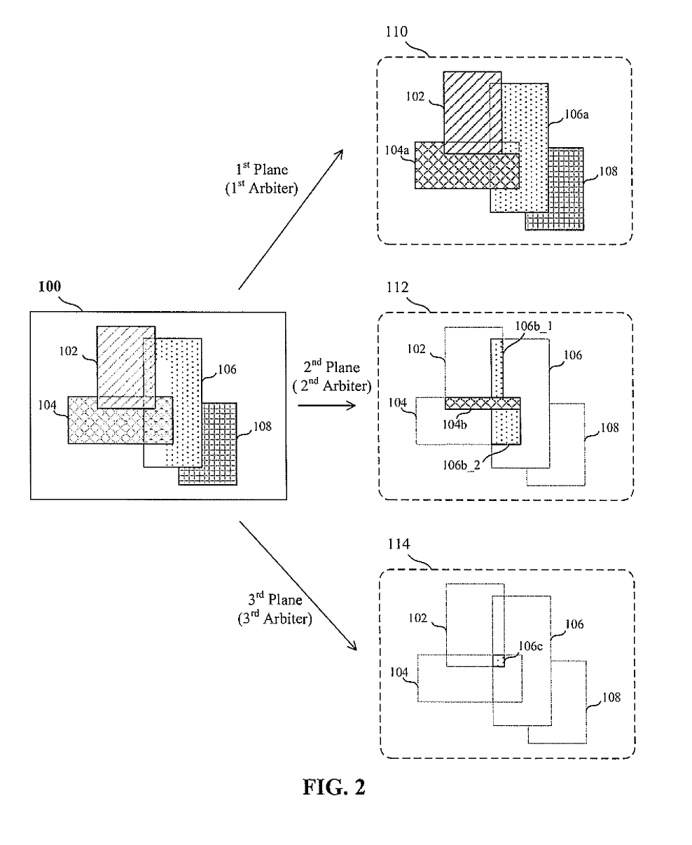

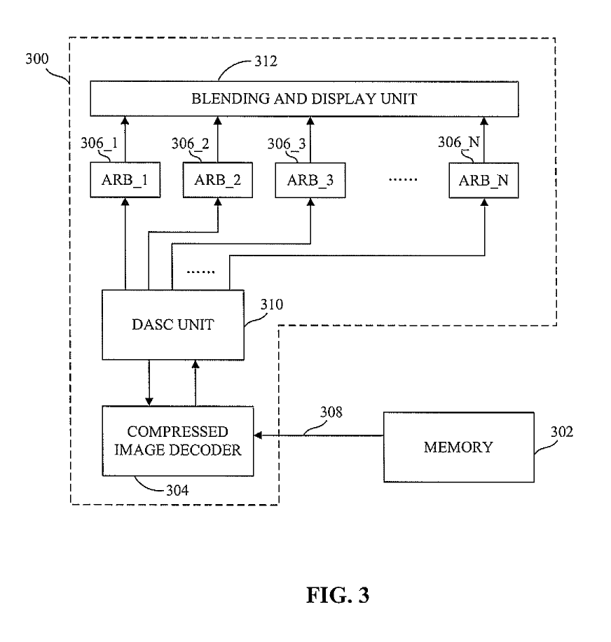

Referring now to FIG. 3, a schematic block diagram illustrating a multi-layer display system 300 for displaying a plurality of images at N planes of a single frame in accordance with an embodiment of the present invention is shown, where N is a natural number equal to or greater than 2. The plurality of images includes at least one compressed image stored in a memory 302 connected to the multi-layer display system 300. The memory 302 can be a RAM, ROM or flash memory. The at least one compressed image can be encoded with algorithms like Run-Length Encoding (RLE), Joint Photographic Experts Group (JPEG), or Lempel Ziv Welch (LZW). The multi-layer display system 300 includes a compressed image decoder 304 for decoding the at least one compressed image, for example the third image 106 referring to FIGS. 1 and 2, into a plurality of sets of decoded data, and N arbiters 306_1˜306_N for reading the plurality of sets of decoded data from the compressed image decoder 304. Each of the N arbiters 306_1˜306_N is mapped with one of the N planes, for example, one of the plurality of sets of decoded data of the at least one compressed image read by the arbiter 306_1 is to be displayed at a first plane, and another one of the plurality of sets of decoded data of the at least one compressed image read by the arbiter 306_2 is to be displayed at a second plane, and the like. In a preferred embodiment, the compressed image decoder 304 is connected to the memory 302 through a bus interface 308.

The multi-layer display system 300 further includes a decoder arbitration and semaphore control (DASC) unit 310 connected between the compressed image decoder 304 and the N arbiters 306_1˜306_N for splitting the at least one compressed image into a plurality of segments, assigning at least one of the plurality of segments to one of the N planes. For example, referring back to FIG. 2, the third image 106 is split into the four segments 106a, 106b_1, 106b_2 and 106c. In a preferred embodiment, the DASC unit 310 splits the at least one compressed image into the plurality of segments by determining a boundary of each of the four segments 106a, 106b_1, 106b_2 and 106c. The first segment 106a is assigned to the first plane 110, the second and third segments 106b_1 and 106b_2 are assigned to the second plane 112, and the fourth segment 106c is assigned to the third plane 114. The segments 106a-106c are used for defining barriers during decoding the compressed image. The DASC unit 310 further allows one of the N arbiters 306_1˜306_N to access the compressed image decoder 304 to read a set of decoded data of one of the plurality of segments assigned to one of the N planes mapped with the one of the N arbiters 306_1˜306_N when decoding of the one of the plurality of segments is being performed and the one of the plurality of segments of the compressed image is required by the one of the N arbiters. In a preferred embodiment, the DASC unit 310 stops the one of the N arbiters 306_1˜306_N from accessing the compressed image decoder 304 when the decoding of the one of the plurality of segments is not being performed. For example, the DASC unit 310 allows the first arbiter 306_1 to access the compressed image decoder 304 to read decoded data of the first segment 106a and stops other arbiters from accessing the compressed image decoder 304 when the compressed image decoder 304 is decoding the first segment 106a.

In a preferred embodiment, the compressed image decoder 304 decodes the compressed image according to a sequence of encoding the compressed image. For example, pixel data of the compressed image that is first encoded will be decoded first. In another preferred embodiment, sets of decoded data of the plurality of segments that are not assigned to any one of the N planes are discarded by the DASC unit 310.

The compressed image decoder 304 is shared among the N arbiters and dynamically accessed by the N arbiters with the DASC unit 310, so that only one compressed image decoder is required and memory for storing decoded data of the compressed image is saved.

In a further preferred embodiment, the multi-layer display system 300 further includes a blending and display unit 312 connected to the N arbiters 306_1˜306_N for receiving and blending the plurality of sets of decoded data of the at least one compressed image from the N arbiters, and displaying the at least one compressed image. The compressed image decoder 304, the DASC unit 310, the N arbiters 306_1˜306_N and the blending and display unit 312 can be a part of a processor, such as a CPU, a MCU or a DPU.

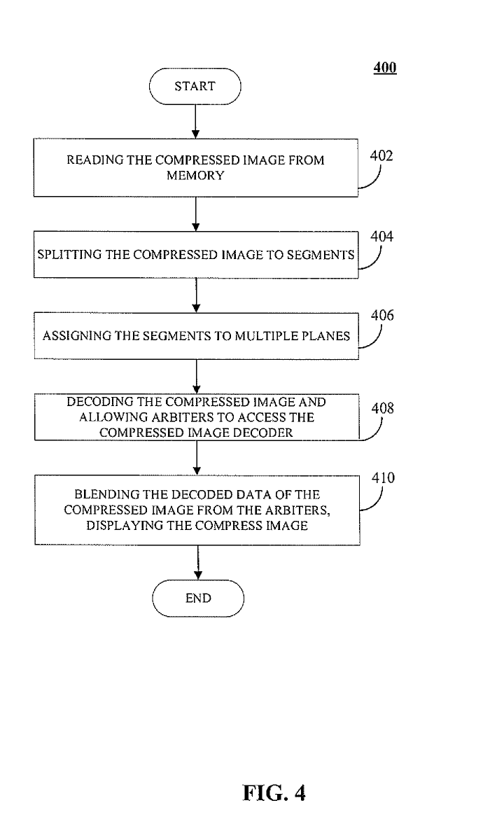

Referring now to FIG. 4, a flow chart depicting a method 400 for displaying a plurality of images at multiple planes by a multi-layer display system in accordance with an embodiment of the present invention is shown. Steps in the flowchart of FIG. 4 have been explained in conjunction with FIGS. 1˜3.

The plurality of images are stored in the memory 302 connected to the compressed image decoder 304 of the multi-layer display system. In this example, the third image 106 is in a compressed form, for example, encoded through algorithms like Run-Length Encoding (RLE), Joint Photographic Experts Group (JPEG), or Lempel Ziv Welch (LZW).

Starting at step 402, the compressed image decoder 304 reads the third image 106 from the memory 302. At step 404, the decoder arbitration and semaphore control (DASC) unit 310 accesses the compressed image decoder 304 and splits the third image 106 into a plurality of segments, such as the segments 106a, 106b_1, 106b_2 and 106c. In a preferred embodiment, the DASC unit 310 splits the compressed image (106) into the plurality of segments by determining a boundary of each of the four segments 106a, 106b_1, 106b_2 and 106c. At step 406, the DASC unit 310 assigns the plurality of segments to multiple planes, for example, the first segment 106a is assigned to the first plane 110, the second and third segments 106b_1 and 106b_2 are assigned to the second plane 112, and the fourth segment 106c is assigned to the third plane 114. The plurality of segments are used for defining barriers during decoding of the compressed image.

At step 408, the compressed image decoder 304 starts to decode the third image 106. In a preferred embodiment, the compressed image decoder 304 decodes the third image 106 according to a sequence of encoding the third image 106. For example, data of pixels of the third image 106 that is first encoded will be decoded first. Meanwhile, the DASC unit 310 allows one of the N arbiters 306_1˜306_N to access the compressed image decoder 304 when one of the plurality of segments that is assigned to a plane mapped with the one of the N arbiters 306_1˜306_N is being decoded and required by the one of the N arbiters, so that the one of the N arbiters 306_1˜306_N can read decoded data of the one of the plurality of segments. In a preferred embodiment, the DASC unit 310 stops the one of the N arbiters 306_1˜306_N from accessing the compressed image decoder 304 when the decoding of the one of the plurality of segments is not being performed. For example, when the first segment 106a is being decoded, the DASC unit 310 allows the first arbiter 306_1 to access the compressed image decoder 304 to read decoded data of the first segment 106a, which is to be displayed at the first plane 110, and stops other arbiters from accessing the compressed image decoder 304. In another preferred embodiment, sets of decoded data of the plurality of segments that are not assigned to any one of the N planes are discarded by the DASC unit 310.

At step 410, the blending and display unit 312 receives the plurality of sets of decoded data of the third image 106 from the N arbiters 306_1˜306_N, blends the plurality of sets of decoded data from the N arbiters, and displays the third image 106 at the N planes in a single frame. Therefore, the compressed image decoder 304 is shared among the N arbiters and dynamically accessed by the N arbiters with the DASC unit 310, so that only one compressed image decoder is required and memory for storing decoded data of the compressed image is also saved.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A display system for displaying a plurality of images at multiple planes in a single frame, wherein the plurality of images includes at least one compressed image, the display system comprising:
a compressed image decoder for decoding the at least one compressed image into a plurality of sets of decoded data;
a plurality of arbiters for reading the plurality of sets of decoded data from the compressed image decoder, wherein one of the plurality of sets of decoded data read by one of the plurality of arbiters is to be displayed at one of the multiple planes mapped with the one of the plurality of arbiters; and
a decoder arbitration and semaphore control unit connected between the compressed image decoder and the plurality of arbiters for splitting the at least one compressed image into a plurality of segments, assigning at least one of the plurality of segments to one of the multiple planes, and allowing the one of the plurality of arbiters to access the compressed image decoder to read the one of the plurality of sets of decoded data of the one of the plurality of segments assigned to the one of the multiple planes mapped with the one of the plurality of arbiters.

2. The display system of claim 1, further comprising a memory for storing the at least one compressed image, wherein the memory is connected to the compressed image decoder through a bus interface.

3. The display system of claim 1, further comprising a blending and display unit connected to the plurality of arbiters for receiving and blending the plurality of sets of decoded data of the at least one compressed image from the plurality of arbiters, and displaying the at least one compressed image.

4. The display system of claim 1, wherein the decoder arbitration and semaphore control unit splits the at least one compressed image into the plurality of segments by determining a boundary of each of the plurality of segments.

5. The display system of claim 1, wherein the decoder arbitration and semaphore control unit allows the one of the plurality of arbiters to access the compressed image decoder when the at least one of the plurality of segments assigned to the one of the multiple planes mapped with the one of the plurality of arbiters is being decoded by the compressed image decoder and required by the one of the plurality of arbiters.

6. The display system of claim 5, wherein the decoder arbitration and semaphore control unit stops the one of the plurality of arbiters from accessing the compressed image decoder when the at least one of the plurality of segments assigned to the one of the multiple planes mapped with the one of the plurality of arbiters is not being decoded by the compressed image decoder.

7. The display system of claim 1, wherein the plurality of segments includes a segment that is not assigned to any one of the multiple planes, and decoded data of the segment is discarded by the decoder arbitration and semaphore control unit.

8. The display system of claim 1, wherein the compressed image decoder decodes the compressed image according to a sequence of encoding the compressed image.

9. A method for displaying a plurality of images at multiple planes in a single frame with a display system, wherein the plurality of images includes at least one compressed image, and wherein the display system includes a plurality of arbiters and a compressed image decoder for decoding the compressed image, wherein one of the plurality of arbiters is mapped with one of the multiple planes, the method comprising:
splitting the compressed image into a plurality of segments;
assigning at least one of the plurality of segments to one of the multiple planes;
allowing one of the plurality of arbiters mapped with the one of the multiple planes to access the compressed image decoder; and
decoding the plurality of segments into a plurality of sets of decoded data.

10. The method of claim 9, further comprising reading the compressed image from a memory connected to the compressed image decoder through a bus interface.

11. The method of claim 9, further comprising receiving the sets of decoded data of the compressed image from the plurality of arbiters, blending the sets of decoded data, and displaying the compressed image.

12. The method of claim 9, wherein splitting the compressed image into the plurality of segments includes determining a boundary of each of the plurality of segments.

13. The method of claim 9, wherein the one of the plurality of arbiters mapped with the one of the multiple planes is allowed to access the compressed image decoder when the at least one of the plurality of segments assigned to the one of the multiple planes is being decoded by the compressed image decoder and required by the one of the plurality of arbiters.

14. The method of claim 13, further comprising stopping the one of the plurality of arbiters from accessing the compressed image decoder when the at least one of the plurality of segments assigned to the one of the multiple planes mapped with the one of the plurality of arbiters is not being decoded by the compressed image decoder.

15. The method of claim 9, further comprising discarding decoded data of a segment that is not assigned to any one of the multiple planes.

16. The method of claim 9, wherein the compressed image decoder decodes the compressed image according to a sequence of encoding the compressed image.
